(19) United States
(12) Patent Application Publication
(10) Pub. No.: US 2014/0131314 A1
(43) Pub. Date: May 15, 2014

(54) PLASMA PROCESSING APPARATUS AND PLASMA PROCESSING METHOD

(71) Applicant: HITACHI HIGH-TECHNOLOGIES CORPORATION, Tokyo (JP)

(72) Inventors: Yoji ANDO, Kudamatsu (JP); Tetsuo ONO, Kudamatsu (JP); Tatehito USUI, Kasumigaura (JP)

(73) Assignee: HITACHI HIGH-TECHNOLOGIES CORPORATION, Tokyo (JP)

(21) Appl. No.: 13/761,222

(22) Filed: Feb. 7, 2013

(30) Foreign Application Priority Data
Nov. 15, 2012 (JP) 2012-250789

(51) Int. Cl. B05C 11/00

(52) U.S. Cl. CPC B05C 11/00
USPC 216/61; 156/345.24

(57) ABSTRACT

A plasma processing apparatus includes: a processing chamber in which plasma processing is performed; a gas feeding unit which supplied process gas into the processing chamber; a radio-frequency power source which supplies radio-frequency power that turns the process gas fed into the processing chamber to plasma; and a light detector which detects the light emitted from the plasma generated in the process chamber. The light detector includes a detecting unit which detects, during respective preset exposure times, the light emitted from the plasma that is generated due to pulse-modulated radio-frequency power, and a control unit which performs control such that the amount of the light emitted from the plasma during each of the preset exposure times becomes constant.

### BACKGROUND OF THE INVENTION

This invention relates to a plasma processing apparatus and a plasma processing method, for fabricating semiconductor elements, and more particularly for performing plasma processing by stabilizing the intensity of light emitted from working plasma.

The techniques of measuring the light emitted from working plasma through the pulse modulation of plasma are disclosed in the following related art documents. JP-A-2002-270574 discloses a technique in which a radio-frequency power for generating plasma is pulse-modulated and the light emitted from the plasma is measured in synchronism with the frequency used in the pulse modulation. JP-A-2001-168086 (corresponding to U.S. Pat. No. 6,756,311) discloses a unit in which the bias potential is periodically changed and the light from plasma is observed in synchronism with the periodical change of the bias potential.

These related techniques aim at detecting with high precision the light emitted from by-products formed in plasma. Thus, a high precision measurement can be realized by detecting the intensity of light emitted from pulse-modulated plasma in synchronism with the frequency used in the pulse modulation and thereby eliminating signals such as external noise having frequency components unsynchronized with the pulse modulation.

Further, JP-A-2005-217448 disclosed a method wherein the light from plasma is subjected to spectroscopy to obtain desired information at high speed. The disclosed subject is to control the gain by changing the charge accumulation time for a CCD (i.e. abbreviation for charge coupled device).

Also described is a procedure in which the frequency of sampling in a detector is increased to improve the S/N ratio (i.e. signal-to-noise ratio) and the signal is accumulated multiple times and then averaged to eliminate noise components.

In plasma etching, apart from the expectation of the high precision in the measurement of the light from plasma, a technique for modulating plasma with pulses is known which aims at improving the selectivity among different materials to be etched, or making the etching profiles vertical. There have been already plasma etching apparatuses on the market, which are equipped with the function of modulating plasma with pulses.

### SUMMARY OF THE INVENTION

According to the method disclosed in JP-A-2005-217448, wherein the background noise is decreased and also the S/N ratio is improved, by sampling the light from plasma a plurality of times and then taking an average, when electric discharge is pulsed, it may happen that the number of pulses generated within a sampling period fluctuates irregularly.

In this case, the detected intensities of light from plasma for respective sampling periods vary so that improvement in the high-precision detection of light from plasma cannot be expected. In addition, the respective times which are included in the respective sampling periods and for which the plasma is firing (i.e. plasma-on time) may vary from one another depending on the periods of pulse discharge. This case, too, prevents the sensitivity of detecting the light from plasma from being improved.

This invention, which has been made in view of the problems described above, provides a plasma processing apparatus equipped with a highly sensitive light detecting unit for detecting the light emitted from plasma and a plasma processing method using a highly sensitive light detecting unit for detecting the light emitted from plasma.

According to an aspect of this invention, a plasma processing apparatus includes:

a processing chamber in which plasma processing is performed;

a gas feeding unit which supplies process gas into the processing chamber;

a radio-frequency power source which supplies radio-frequency power that turns the process gas fed into the processing chamber to plasma; and

a light detector which detects the light emitted from the plasma generated in the process chamber,

wherein the light detector includes a detecting unit which detects, during each of preset exposure times, the light emitted from the plasma that is generated due to pulse-modulated radio-frequency power, and a control unit which performs control such that the amount of the light emitted from the plasma detected during each preset exposure time becomes constant.

According to another aspect of this invention, there is provided with a plasma processing method using a plasma processing apparatus which includes:

a processing chamber in which plasma processing is performed;

a gas feeding unit which supplied process gas into the processing chamber;

a radio-frequency power source which supplies radio-frequency power that turns the process gas fed into the processing chamber to plasma; and

a light detector which detects the light emitted from the plasma generated in the process chamber,

the plasma processing method including the steps of:

detecting the light from the plasma generated by the radio-frequency power that is pulse-modulated, for each of preset exposure times by the light detector;

performing such a control that the amount of light from the plasma detected during each exposure time is made constant; and

performing plasma processing on the basis of data on the light from the plasma detected by the light detector.

According to this invention, the light emitted from plasma due to pulse discharge can be detected with high sensitivity.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows a plasma etching apparatus as an embodiment of this invention;

FIG. 2 is a timing chart illustrating a relationship between a light detector for detecting plasma used in the embodiment shown in FIG. 1 and the related plasma energization; and

FIG. 3 is a timing chart illustrating a relationship between a light detector for detecting plasma used in a plasma etching apparatus as another embodiment of this invention and the related plasma energization.

### DETAILED DESCRIPTION OF THE EMBODIMENTS

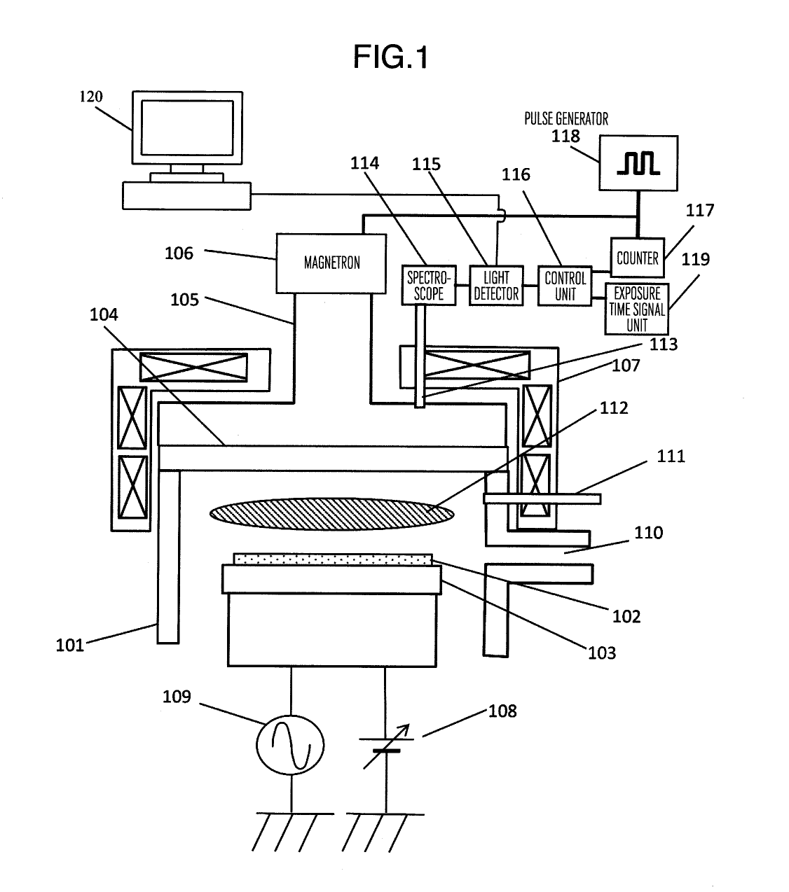

Embodiments of this invention will now be described in reference to the attached drawings. To begin with, a plasma etching apparatus as an embodiment of this invention is described in reference to FIG. 1. FIG. 1 schematically shows a plasma etching apparatus of ECR (Electron Cyclotron Resonance) type which uses microwaves and magnetic field for generating plasma.

The plasma etching apparatus of ECR type comprises a chamber 101 which can be evacuated to a vacuum state; a wafer 102 as samples to be processed; a sample stage 103 for supporting the wafer 102 thereon; a window 104 made of, for example, quartz for letting microwaves pass through; a waveguide 105 provided on and above the window 104; a magnetron 106; a solenoid coil 107 provided around side wall of the chamber 101; a power source 108 connected with the sample stage 103 for electrostatic suction; and a radio-frequency power source 109 for providing radio-frequency power to the sample stage 103.

The wafer 102 is conveyed into the chamber 101 via a wafer charge/discharge opening 110 and then electro-statically sucked to the sample stage 103 due to the help of the power source 108 for electrostatic suction. Then, processing gas is introduced into the chamber 101 via a gas injection nozzle 111. The chamber 101 is depressurized to a predetermined pressure of, for example, 0.1˜50 Pa by means of a vacuum pump (not shown).

The magnetron 106 generates microwaves having a frequency of 2.45 GHz and the generated microwaves are propagated through the waveguide 105 into the chamber 101. The reaction between the microwaves and the magnetic field induced by the solenoid coil 107 causes the processing gas to be excited to generate plasma 112 in the space above the wafer 102.

In the meantime, the radio-frequency power source 109 supplies a bias voltage to the sample stage 103 so that ions in the plasma 112 are accelerated perpendicularly toward the wafer 102 and bombard the surface of the wafer 102. It should be noted here that the radio-frequency power source 109 is so designed as to supply continuous radio-frequency power or time-modulated, intermittent radio-frequency power to the sample stage 103. The wafer 102 is etched anisotropically due to the actions of radicals and ions resulted from the plasma 112.

Light emitted from the plasma 112 is collected by means of an optical fiber 113 and then subjected to spectroscopy in a spectroscope 114. The output of the spectroscope 114 is fed to a light detector 115 including CCDs, which in turn converts the input to an electric signal. The pulse signal generated by a pulse generator 118 pulse-modulates the microwaves generated by the magnetron 106. In response to the pulse-modulation, the plasma 112 is turned on and off to emit light intermittently.

On the other hand, the signal from a pulse generator 118 is fed through a counter 117 to a control unit 116 while the signal from an exposure time signal unit 119 is also fed to the control unit 116. In response to these two signals, the control unit 116 controls the light detector 115, as described below, in such a manner that light detection takes place every time a predetermined number of pulses have been counted or every time a predetermined time during which discharge continues has lapsed.

With this method of control, the light exposure time for the light detector 115 can be controlled so that the number of pulses generated for every light exposure time may become constant. Consequently, the intensity of the light that the plasma 112 emits for every light exposure time may be constant. Further, according to this invention, the light detector 115, the control unit 116, the counter 117 and the exposure time signal unit 119 constitute a light detection unit. The light detection unit also has the function of accumulating the intensities of lights that have been frequency-split by the spectroscope 114 and therefore have different frequencies.

### First Embodiment

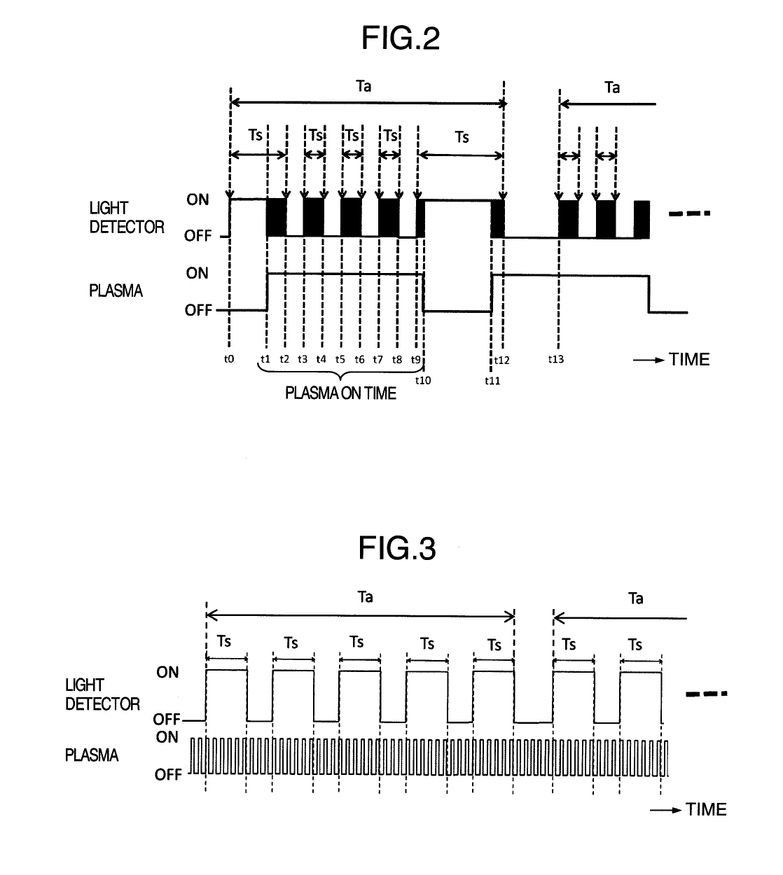

First, explanation is made of a procedure in reference to FIGS. 1 and 2, wherein the accumulated amount of time periods during which the plasma is turned on, is counted within the exposure time (Ts) for the light detector and the exposure time is so controlled as to make each accumulated amount of time periods constant.

Prior to the start of plasma processing, the time period during which the plasma is turned on, that is detected within the exposure time (Ts) is previously defined to be Tpon. The control unit 116, before receiving a pulse-on signal from the pulse generator 118, starts the detection of light emitted from the plasma 112 by the light detector 115.

As shown in FIG. 2, the light detector 115 is ready for the detection of light at a time instant to. The state in which light detection is possible is represented as “ON”. As soon as the magnetron 106 has received an ON signal from the pulse generator 118, it generates microwaves to form plasma. In FIG. 2, it is shown that plasma is turned on at a time instant t1.

In the duration from t0 to t1, _the plasma does not emit light, but the light detector 115 is continuously in the state of being exposed to light from the plasma. At the time instant t1, as the magnetron 106 is turned on and the plasma starts to emit light, the light detector 115 starts to accumulate the light from the plasma. Simultaneously, the counter 117 starts to accumulate the ON durations of plasma to generate a plasma-on time accumulation value (hereafter referred to as Tpon). In FIG. 2, the pulses painted black for the light detector 115 represent where the plasma ON durations are accumulated.

When the ongoing plasma-on time accumulation value reaches a preset Tpon, the exposure to plasma light of the light detector 115 terminates at t2 while the plasma continues to emit light. The exposure data accumulated by the light detector 115 from t2 to t3 is transferred to an external PC 120, etc. and the accumulated data is reset. This time period is fixed with respect to the light detector 115 and the time period from the termination of an exposure to plasma light to the start of the next exposure to plasma light is made constant.

Then, the exposure to light is started at the time instant t3 and the accumulation of data on plasma light is continued until a time instant t4 is reached. When the preset Tpon (t4) is reached, the transfer and the reset of the data on exposure to light are performed. Through the repetitions of these series of operations, data on plasma light continues to be obtained. As the plasma is continuously in the ON state during each exposure time (Ts) in the time period from the time instant t3 to a time instant t8, Ts becomes equal to Tpon. The same is true in the last step of pulse. In fact, even when discharge terminates at t9, exposure to light continues until Tpon reaches the preset value after the restart of discharge.

As described above, data on plasma light emission is obtained N times over N exposure times and the average over the N times is displayed on, for example, the screen of a PC as the graph showing the intensity of light emitted from plasma against the time elapsed. FIG. 2 shows an example in which the average is taken over five exposure times. The sampling time for calculating the average is denoted as Ta. In this embodiment, Ts is several to several tens of milliseconds and the times N for calculating the average ranges from several tens to several hundreds. The sampling time Ta falls within the interval of 0.1 sec˜1 sec.

By controlling the exposure time (Ts) for plasma light as described above, the time during which plasma is turned on, i.e. plasma-on time, within each exposure time (Ts) can be made constant so that the amount of light emitted from the plasma during every sampling period can be made constant. Further, in the embodiment described above, though the pulses for plasma excitation is not synchronized with the time instant of the start of the exposure time with respect to the light detector, such synchronization may be realized.

In the above embodiment, the off-time of exposure is set by controlling the exposure time with respect to the light detector 115 by the control unit 116. However, such an off-time need not be set necessarily. Alternatively, for example, a sufficient number of registers may be provided which can store the output signal from the light detector 115 to continue exposure to light from plasma even during the time for which the signal is being transferred, and the signal may be stored in the registers to be successively transferred to an external PC, etc.

This embodiment exemplifies the case where the plasma-on time exceeds the exposure time (Ts), but there may be a case where the plasma-on time is shorter than the exposure time (Ts). In the latter case, too, the procedure which counts the accumulation of plasma-on times within each exposure time (Ts) as described in this embodiment may be available. Explanation is made in reference to FIGS. 1 and 3, of a different method in which the number of pulses is counted so that the exposure time (Ts) with respect to the light detector 115 is controlled in such a manner that the count of pulses becomes constant for every exposure time.

### Second Embodiment

The plasma 112 is periodically turned on and off due to the microwaves generated by the magnetron 106 and pulse-modulated by the ON/OFF signal supplied from the pulse generator 118.

In order to set exposure to light from plasma, the pulse-on signal is sent from the pulse generator 118 to the control unit 116; in synchronism with the pulse-on signal, the light detector 115 starts exposure to light from plasma at t0; and the counter 117 counts the number of pulses generated by the pulse generator 118.

When the number of the pulses counted by the counter 117 has reached the preset value, the control unit 116 sends a signal for terminating the exposure to light of the light detector 115 to the light detector 115, which then terminates its exposure to light from plasma at time instant t1. The data on the emitted light accumulated from t0 to t1 is transferred to the external PC 120 and thereafter the accumulated data is reset. Such accumulation of data on emitted light is repeated N times, and the average over the N time accumulations is calculated so that sampling at a predetermined interval is performed to display the time-variation of the emitted light on, for example, the screen of the external PC 120. In FIG. 3 is shown a case where the average is calculated over five time accumulations, and the time required for a single sampling is Ta.

As described above, if the exposure time is so controlled that the number of pulses within each exposure time remains constant, then the light emitted from plasma within each sampling time can be detected stably.

Further, another type of control is possible where the number of pulses within each exposure time is not constant, but the values of the outputs are weighted with correcting factors in proportion to the amplitudes of the pulses so that the resulted values become constant. For example, even in the case where some factor caused a fluctuation in the exposure time (Ts) so that the number of pulses counted within a certain exposure time was not constant, say, smaller by one than the preset standard value Ns, that is, Ns−1, the signal output from the light detector 115 can be made constant if the signal output from the light detector 115 is multiplied by a factor equal to Ns/(Ns−1).

Moreover, in order to make constant the number of pulses for modulating the plasma detected within each exposure time, the pulses need not be counted, but a frequency value preset in the pulse generator 118 may be utilized. The frequency for pulse modulation of plasma is preset in the recipe that defines the conditions for plasma etching. Therefore, the period Tp can be calculated as the reciprocal of the frequency preset in the recipe, and if the exposure time for which light from plasma is detected is set to be an integral multiple of the period Tp, the number of plasma modulation pulses detected within each exposure time can be made constant.

It is customary that the period (i.e. repetition period) Tp of plasma modulation pulses is optimized depending on, for example, such a feature as etching profile, whereas the exposure time (Ts) for the light detector 115 is optimized depending on the intensity of the light emitted from the plasma. Accordingly, the magnitudes of Tp and Ts are determined depending on the etching characteristic and the plasma light intensity. With these facts in mind, explanation will now be made below about a measure that switches between two methods of control: one is to make control such that the number of plasma modulation pulses detected within each exposure time can be made constant depending on the magnitudes of the period Tp of the plasma modulation pulses and the exposure time (Ts) of the light detector 115; and the other is to control each exposure time so that the time amount Tpon as the accumulation of the plasma-on times detected for each exposure time can be made constant.

### Third Embodiment

The exposure time (Ts) of the light detector 115 and the period Tp of the plasma modulation pulses are determined when the related plasma processing conditions are prepared. If the exposure time (Ts) of the light detector 115 is longer than the period Tp of the plasma modulation pulses (i.e. Ts>αTp), the light from plasma is detected, as described in the above second embodiment, while controlling each exposure time in such a manner that the number of plasma modulation pulses detected within each exposure time can be made constant. It should be noted here that α is not less than 10.

On the other hand, if the exposure time (Ts) of the light detector 115 is shorter than the period Tp of the plasma modulation pulses (i.e. Ts<αTp), the light from plasma is detected, as described in the above first embodiment, while controlling each exposure time in such a manner that the time amount Tpon as the accumulation of the plasma-on times detected for each exposure time can be made constant. It should also be noted here that α is not less than 10.

As described above, if the control unit 116 performs such a control that switches between the control wherein the number of plasma modulation pulses detected within each exposure time can be made constant depending on the magnitudes of the period Tp of the plasma modulation pulses and the exposure time (Ts) of the light detector 115 and the control wherein each exposure time is so controlled that the time amount Tpon as the accumulation of the plasma-on times detected for each exposure time can be made constant, then an optimal control method can be automatically selected and therefore the light from plasma can be detected stably irrespective of the magnitudes of the period Tp of the plasma modulation pulses and the exposure time (Ts) of the light detector 115.

In the respective embodiments given above, this invention is described as applied to a plasma etching apparatus of ECR (Electron Cyclotron Resonance) type that utilizes microwaves. This invention, however, is not limited to such an application at all, but can be likewise applied to a plasma etching apparatus using a plasma generating unit of electrostatic capacitance-coupled type or inductance-coupled type.

Further, as described in the first embodiment, according to this invention, each exposure time is controlled in such a manner that the time amount Tpon as the accumulation of the plasma-on times detected for each exposure time can be made constant. Moreover, as described in the second embodiment, according to this invention, each exposure time is controlled in such a manner that the number of plasma modulation pulses detected within each exposure time can be made constant.

Furthermore, as described in the third embodiment, according to this invention, change over is made between the control wherein each exposure time is so controlled that the number of plasma modulation pulses detected within each exposure time can be made constant depending on the magnitudes of the period Tp of the plasma modulation pulses and the exposure time (Ts) of the light detector 115 and the control wherein each exposure time is so controlled that the time amount Tpon as the accumulation of the plasma-on times detected for each exposure time can be made constant.

In fact, the gist of this invention is to make control such that the amount of light emitted from the pulse-modulated plasma that is detected within each exposure time of the light detector 115 can be made constant. Accordingly, also included in the scope of this invention is to make constant the amount of light emitted from plasma that is detected within each exposure time, by synchronizing the pulses for modulating the plasma with the exposure times of the light detector 115. It should be noted here that the synchronization of the pulses for modulating the plasma with the exposure times of the light detector 115 means the concurrence between the time instant at which each pulse starts and the time instant at which each exposure time starts.

As described above, the practice of this invention will make it possible to make constant the amount of light emitted from plasma that is detected within each exposure time and therefore to detect light emitted from plasma due to pulse discharge with high sensitivity.

It should be further understood by those skilled in the art that although the foregoing description has been made on embodiments of the invention, the invention is not limited thereto and various changes and modifications may be made without departing from the spirit of the invention and the scope of the appended claims.

1. A plasma processing apparatus comprising:
a processing chamber in which plasma processing is performed;
a gas feeding unit which supplies process gas into the processing chamber;
a radio-frequency power source which supplies radio-frequency power that turns the process gas fed into the processing chamber to plasma; and
a light detector which detects light emitted from the plasma generated in the process chamber,
wherein the light detector includes a detecting unit which detects, during each of preset exposure times, the light emitted from the plasma that is generated due to pulse-modulated radio-frequency power, and a control unit which performs control such that the amount of the light emitted from the plasma detected during each preset exposure time becomes constant.

2. The plasma processing apparatus according to claim 1, wherein the control unit performs control such that the amount of the light emitted from the plasma during each preset exposure time is made constant by synchronizing the pulses for modulating the plasma with the preset exposure times.

3. The plasma processing apparatus according to claim 1, wherein the control unit controls each of the preset exposure times such that the value as the accumulation of the periods during each of which the plasma is turned on to emit light and all of which fall within each of the preset exposure times, is made constant.

4. The plasma processing apparatus according to claim 1, wherein the control unit controls each of the preset exposure times in such a manner that the number of plasma modulation pulses detected within each exposure time can be made constant.

5. The plasma processing apparatus according to claim 1, wherein the control unit switches between the control wherein each exposure time is so controlled that the time amount as the accumulation of plasma-on times detected for every exposure time can be made constant in response to the magnitudes of the period of the plasma modulation pulses and the exposure time and the control wherein the number of plasma modulation pulses detected within each exposure time can be made constant.

6. The plasma processing apparatus according to claim 1, wherein data on light from plasma obtained through sampling by the light detector is the average of a predetermined number of data on light from plasma detected during each exposure time.

7. A plasma processing method using a plasma processing apparatus including:
a processing chamber in which plasma processing is performed;
a gas feeding unit which supplied process gas into the processing chamber;
a radio-frequency power source which supplies radio-frequency power that turns the process gas fed into the processing chamber to plasma; and
a light detector which detects light emitted from the plasma generated in the process chamber,
the plasma processing method comprising the steps of:
detecting, by the light detector, the light from the plasma generated by the radio-frequency power that is pulse-modulated, for each of preset exposure times of the light detector;
performing such a control that the amount of light from the plasma detected during each exposure time is made constant; and
performing plasma processing on the basis of data on the light from the plasma detected by the light detector.

8. The plasma processing method according to claim 7, further comprising the step of performing control in such a manner that the amount of the light emitted from the plasma detected during each of the preset exposure times by the light detector is made constant by synchronizing the pulses for modulating the plasma with the preset exposure times of the light detector.

9. The plasma processing method according to claim 7, further comprising the step of controlling each of the exposure times of the light detector in such a manner that the value as the accumulation of the plasma-on times, during each of which the plasma is turned on to emit light and all of which fall within each of the exposure times, is made constant.

10. The plasma processing method according to claim 7, further comprising the step of controlling the respective exposure times of the light detector in such a manner that the number of plasma modulation pulses detected within each exposure time is made constant.

11. The plasma processing method according to claim 7, further comprising the step of switching between the control wherein each exposure time of the light detector is so controlled that the value as the accumulation of plasma-on times detected for each exposure time can be made constant depending on the magnitudes of the period of the plasma modulation pulse and the exposure time and the control wherein the number of plasma modulation pulses detected within each exposure time can be made constant.

12. The plasma processing method according to claim 7, wherein data on light from plasma obtained through sampling by the light detector is the average of a predetermined number of data on light from plasma detected during each exposure time.
